(19) United States
(12) Patent Application Publication
(10) Pub. No.: US 2006/0178103 A1
(43) Pub. Date: Aug. 10, 2006

(54) Adjustable height meat skinner

(75) Inventors: Matthew A. Bergman, Des Moines, IA (US); Matthew P. Sawhill, Des Moines, IA (US); James L. Myers, Urbandale, IA (US)

Correspondence Address: ZARLEY LAW FIRM P.L.C., CAPITAL SQUARE, 400 LOCUST, SUITE 200, DES MOINES, IA, 50309-2350, US

(73) Assignee: Townsend Engineering Company, Des Moines, IA (US)

(21) Appl. No.: 11/053,224

(22) Filed: Feb. 8, 2005

(51) Int. Cl. A22B 5/16

(52) U.S. Cl. 452/125

(57) ABSTRACT

A skinning machine having a height adjustment assembly to raise and lower a primary cabinet in relation to the supporting legs.

### BACKGROUND OF THE INVENTION

Meat skinning machines are well known in the art and are either installed as part of a conveyor system or used as an open top skinner. The ability to adjust the height of the meat skinning machine is desired either to align the skinning machine with compatible pieces or to change the height to accommodate the height of the operator.

Fixed height skinning machines do not always achieve the most ergonomic working conditions which is generally at about the elbow height of the operator. This may lead to both physical and mental stress for the operator. Further, these fixed skinning machines are not adjustable to accommodate for operator fatigue during a shift. Also, fixed skinning machines are not adaptable to various conveyor layouts which results in costly, time consuming, and labor intensive layout changes.

Some attempts have been made to overcome these problems such as mounting the skinning machine to the ceiling, raising the entire machine up and down, or raising and lowering the surface that the operator stands on. These devices are difficult to operate and often, because of the nuisance, operators will tolerate an undesirable height or will find a box or similar device to stand on. This creates the potential for injury which according to OSHA is one of the leading causes of injury. Accordingly, there exists a need in the art.

Therefore, the principal objective of the present invention is to provide a meat skinning machine where the height of the machine is easy to adjust.

Another objective of the present invention is to provide a meat skinning machine that allows for optimal ergonomic conditions.

Still another objective of the present invention is to provide a meat skinning machine with a height adjustment assembly having few parts.

These and other objectives, features, and advantages, will become apparent from the specification and claims.

### BRIEF SUMMARY OF THE INVENTION

A meat skinning machine mounted on legs having a height adjustment assembly to raise and lower the skinning machine in relation to the legs.

### BRIEF DESCRIPTION OF THE DRAWINGS

FIG. 1 is a front view of a meat skinning machine with a height adjustment assembly;

FIG. 2 is a side view of meat skinning machine with a height adjustment assembly; and

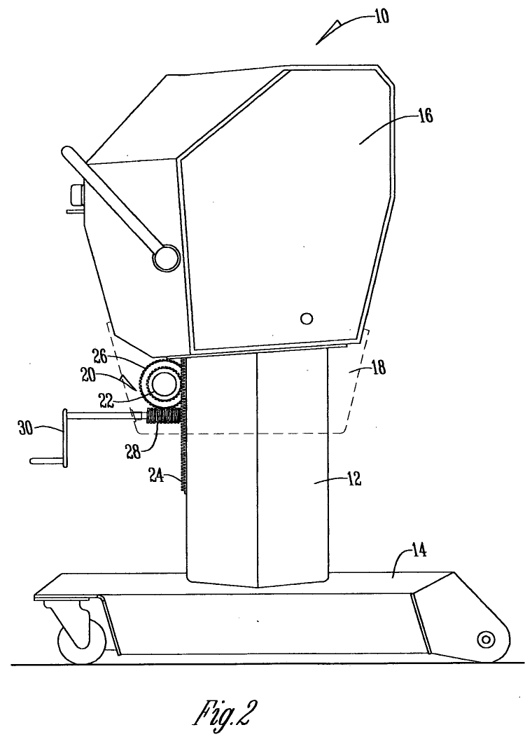

FIG. 3 is a perspective view of a meat skinning machine with a height adjustment assembly.

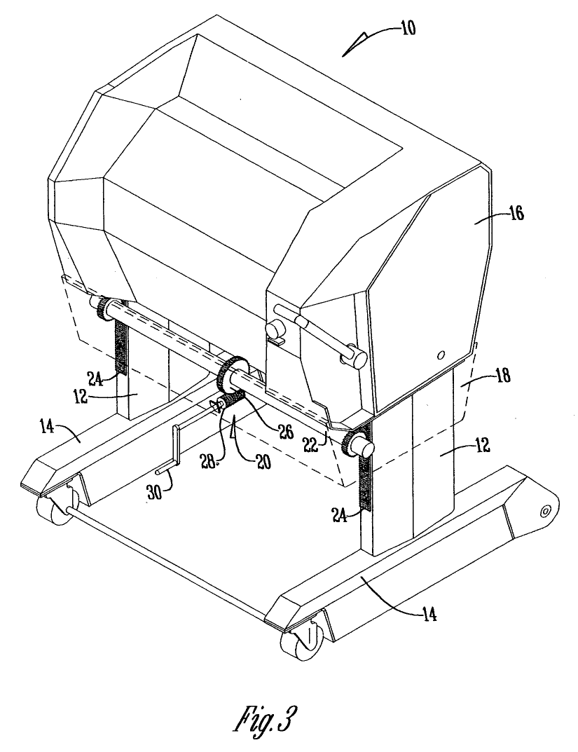

### DETAILED DESCRIPTION OF THE PREFERRED EMBODIMENT

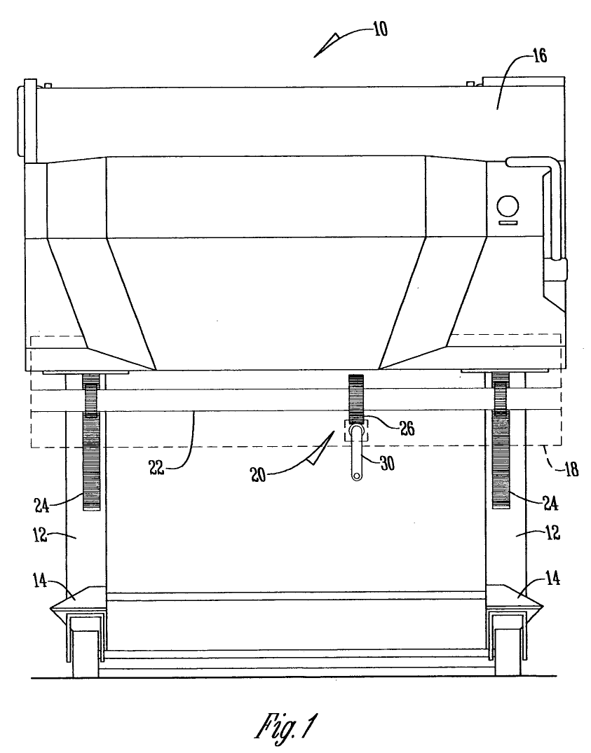

FIG. 1 shows a meat skinning machine 10 mounted on a pair of legs 12 that are connected to a pair of elongated support members 14. While an open top skinning machine is shown, understood is that any type of skinning machine may be used including automatic skinning machines for conveyor systems.

The skinning machine has a primary cabinet 16 that houses the skinning assembly (not shown). Extending below the primary cabinet is a sub cabinet 18 that contains the height adjustment assembly 20 and receives the legs 12 through openings in the bottom of the sub cabinet. One skilled in the art could appreciate that the primary cabinet 16 and the subcabinet 18 could be combined to form a single housing for the skinning assembly and the height adjustment assembly 20. While the height adjustment assembly 20 can take many forms, preferred is an elongated pinion 22 that is mounted to the interior of the sub cabinet 18 and engages racks 24 mounted on the legs 12. Mounted on the pinion 22 is a radially extending gear 26. The gear 26 is positioned to engage a shaft 28 that extends outwardly through the sub cabinet 18 and is connected to a crank shaft 30.

In operation, the height of the skinning machine 10 is adjusted by rotating the crank shaft 30 in a first direction which in turn rotates the shaft 28 in the same direction. The shaft 28 engages and rotates the worm gear 26 which in turn rotates the pinion 22. As the pinion 22 rotates and engages the rack 24, the sub cabinet 18 and in turn the primary cabinet of the skinning machine 10 is raised. By rotating the crank shaft 30 in an opposite direction, the skinning machine is lowered in a similar manner. In the alternative, the skinning machine can be raised and lowered with a powered source (not shown).

Accordingly, disclosed is a height adjusting assembly for a skinning machine that easily raises and lowers the skinning machine to adjust to the height of the operator or other compatible devices. Thus, at least the stated objectives have been met.

1. A meat skinning machine mounted on support legs; comprising;
a housing having a primary cabinet for housing a skinning assembly;
a sub-cabinet that contains a height adjusting assembly; at least one leg received within the sub-cabinet; and
said height adjusting assembly mounted to the leg to raise and lower the sub-cabinet in relation to the legs.

2. (canceled)

3. The machine of claim 1 wherein the height adjusting assembly further comprises a crank shaft operatively connected to the legs.

4. The machine of claim 1 wherein the height adjusting assembly further comprises racks mounted to the legs that engage a pinion that extends between the legs.

5. The machine of claim 1 wherein the height adjusting assembly is connected to a power source.

6. The meat skinning machine of claim 1 wherein the
height adjustment assembly comprises:
an elongated pinion that is mounted to the sub-cabinet;
at least one rack mounted on the leg of the meat skinning machine and engaged by the pinion;
a radially extending gear mounted on the pinion and
a crank shaft connected to the gear such that when the crankshaft is rotated the meat skinning machine is raised and lowered.

7. The meat skinning machine of claim 6 wherein a shaft engages the gear and extends outwardly through the sub-cabinet and is connected to the crank shaft.

8. The meat skinning machine of claim 5 wherein a shaft engages the gear and extends outwardly through the sub-cabinet and is connected to the crank shaft.

9. The meat skinning machine of claim 5 wherein the radially extending gear is a worm gear.
